(19) United States
(12) Patent Application Publication
(10) Pub. No.: US 2014/0359014 A1
(43) Pub. Date: Dec. 4, 2014

(54) SYSTEMS AND METHODS FOR CONTENT MANAGEMENT

(71) Applicant: SEAHORSE, INC., San Francisco, CA (US)

(72) Inventors: Oskar HJERTONSSON, San Francisco, CA (US); Daniel UNDURRAGA, San Francisco, CA (US)

(73) Assignee: SEAHORSE, INC., San Francisco, CA (US)

(21) Appl. No.: 14/284,347

(22) Filed: May 21, 2014

Related U.S. Application Data
(60) Provisional application No. 61/830,406, filed on Jun. 3, 2013.

(51) Int. Cl. H04L 12/58

(52) U.S. Cl. CPC H04L 51/046
USPC 709/204

(57) ABSTRACT

A method and apparatus for managing curation of the content of a network-based shared folder may comprise: creating, via a user computing device having Internet access, an originating curator created folder; selecting, via the user computing device, originating curator selected content and incorporating the originating curator selected content into the originating curator created folder; designating, via the user computing device, at least one other to act as curator of the content kept in the originating curator created folder to the same extent as the originating curator, for the content kept in the originating curator created folder at the time of the designation of the at least one other curator and up until the at least one other curator is deleted as a curator for the folder. The method and apparatus may allow the deleted curator access to the content at the time the deleted curator is deleted.

### RELATED CASES

This application claims priority to U.S. Provisional Patent Application Ser. No. 61/830,406, entitled, SYSTEMS AND METHODS FOR CONTENT MANAGEMENT, filed on Jun. 3, 2013, the disclosure of which is incorporated in the present application for all purposes as if the Provisional Application, including the entire specification, claims and drawing, were repeated here fully and completely.

### BACKGROUND

The cost of storing electronic data has continued to decrease over the past 10 years, while the quality and availability of electronic photos and videos has increased. As a result of these technology trends a variety of solutions have been developed for sharing photos. 7 Moments provides private photo albums for the web and iPhone®. The services allows users to create a free private photo album and share their moments with friends, family or any group of people. 23 Snaps is a secure mobile application that allows parents to save and share videos and updates of their children with a select group of family and friends. Albumatic enables users to create an album at the beginning of an ongoing event and add friends who are located nearby to contribute photos as the event happens. Users can “like” or comment on photos. Animoto provides a slideshow service that allows users to share photos by turning them into videos. See, U.S. Pat. No. 8,347,213 issued Jan. 1, 2013, to Clifton et al for Automatically Generating Audiovisual Works. Cluster helps a group of people exchange photos after a shared event. Cluster is used for swapping and sharing photos. Cooloris is an application that allows users to selectively share photos which are collected from different sources. Flickr is a popular website that allows users to share photographs. Flock finds photos taken together with friends and family and brings the photos together into a single shared album. Fotki is a photo sharing community which also offers printing services. Kee.ps brings together photos and videos from events. LivePix is a private photo collaboration tool which allows users to device who to invite to an invite. LivePix also allows photos to be organized by time.

The problem with current solutions is that many photos lack direction and are not organized—either on a user's computer or their portable electronic device. Additionally, photos are located on many disperse platforms and may easily and inadvertently be deleted. Moreover users are not able to share ownership with an album at unique points in time and retain access to the album even if their status with relationship to the album changes.

### SUMMARY

Collaboration is a sophisticated skill that asks people who work together to look beyond personal interests towards outcomes benefiting the whole. Collaboration is a great way to address complex challenges, since it has the potential to tap communal creativity and unleash true innovation and earn genuine buy-in. The biggest value that social networks offer goes beyond being marketing channels to push communication to prospects and customers. They are morphing into new channels for collaboration and innovation. Social networks are becoming unique touch points to engage communities, start conversations, recruit skillful employees, and develop new innovative ideas. The systems and methods provided herein are primarily online services that enable users to collaborate on private photo albums and other types of content. A distinctive feature is that collaboration with close groups offers a long term solution to privacy, easy sharing and joint storage costs. Users may stop relying on traditional social media options, and instead use this application for more efficient curation, i.e., action taken by multiple curators for the album, and efficient and effective targeted sharing. As used in the present application curator shall have the same meaning as collaborator in creating/managing the content of an album(s).

It will be understood that a method and apparatus is disclosed for managing the video content of a network-based shared folder which may comprise creating, via a user computing device having Internet access, an originating member-created folder; selecting, via the user computing device, originating member selected video content and incorporating the originating member selected video content into the originating member-created folder; designating, via the user computing device, at least one other user as a member collaborating in the management of the video content kept in the originating member-created folder to the same extent as the originating member, for the video content kept in the originating member-created folder at the time of the designation of the at least one other member and up until the at least one other originating member-created folder comprising selecting video content to place into or remove from the originating member-created folder. Acting as a member of the originating member-created folder may comprise selecting an additional member to add to the or delete from the video content in the originating member-created folder and may comprise being selected by the originating member as a starred member for the originating member-created folder and having the ability to select an additional starred member for the originating member-created folder. Each folder may remain private to the existing members of the folder. The apparatus and method may comprise preventing any member of an originating member-created folder having more than one member from deleting video content from the folder after the passage of a selected relatively short period of time.

A machine readable medium storing instructions that, when executed by a computing device, cause the computing device to perform a method for managing the video content of a network-based shared folder, is also disclosed, where the method may comprise creating a network-based originating member-created folder; selecting originating member selected video content and incorporating the originating member selected video content into the originating member-created folder; and designating at least one other user as a member collaborating in the management of the video content kept in the originating member-created folder to the same extent as the originating member, for the video content kept in the originating member-created folder at the time of the designation of the at least one other member and up until the at least one other member is deleted as a member for the folder.

As described herein, the system is configurable to allow any user to add content, such as photos and videos, to a folder or album of which they are a member. The system is also configurable to allow any user to remove content from a folder for which they are a member for a definable period of time that is configured to allow removals of content. After that the definable period of time allowing removable, content cannot be removed by anyone from the folder. A definable period of time could be, for example, 1 day, 5 days, 7 days, etc. When content is removed from a folder, the system is configurable such that the uploading user can still access the content (e.g, if a user adds a photo another user does not like, even if the photo is removed from everyone in the folder, the user who uploaded the photo can still access it. Any user can be designated with rights to add and remove other users as members of a folder. Such designation could be, for example, by placing a “star” next to the user's name for that particular folder. The user that creates a folder gets a star automatically by virtue of having created the folder. All other stars are granted by someone in the folder that has a star. Once a member has a star in a folder, that user privileges associated with a star cannot be removed by the user or by other members of the folder. When a member of a folder, with or without star, is removed by another member with a star its gets a replica of the album that captures all of the content in the album as of the date and time the member was removed. This replica includes all content (photos, videos), as well as comments and meta data. Whether the removed member had a star or not when removed does not matter. The replica folder will not grant the user with star privileges to the data and any copies of data from the replica folder will remove all comments and meta data. Thus, the user can copy the content to another album, and share the content with new people, but the user cannot invite new people to the replica folder or share the social context of the content in the replica folder with others. When a user voluntarily leaves an album, the user can choose to leave with or without a copy (replica). The same rules apply to the replica for a user that voluntary leaves as though the user been removed. The grace period for removing content from a folder, also applies to the removal of members from a folder. If a user leaves or is removed from a folder within a definable period of time, e.g., 7 days, the departing user does not get a replica.

### INCORPORATION BY REFERENCE

All publications, patents, and patent applications mentioned in this specification are herein incorporated by reference for all purposes and as if the publication, patent or patent application were repeated verbatim in the present application, including the specification, claims, if any, and drawings, to the same extent as if each individual publication, patent, or patent application was specifically and individually indicated to be incorporated by reference in the present application.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which content management can be achieved;

FIG. 1B is a block diagram of an exemplary computing environment through which content management can be achieved;

FIG. 1C is an illustrative architectural diagram showing some structure that can be employed by devices through which content management is achieved;

FIG. 2 is a block diagram showing the cooperation of exemplary components of a system suitable for use in a system where content management is achieved;

FIG. 3 is a screen shot/display showing a mobile device with 12 images, and three selected according to aspects of embodiments of the disclosed subject matter;

FIG. 4 is a screen shot/display showing a tool bar which enables a user to organize images, e.g., by date the image was created according to aspects of embodiments of the disclosed subject matter;

FIG. 5 is a screen shot/display showing a commenting function for the images according to aspects of embodiments of the disclosed subject matter;

FIG. 6 is a screen shot/display showing a pop-up requesting further information from the user according to aspects of embodiments of the disclosed subject matter;

FIG. 7 is a screen shot/display showing albums according to aspects of embodiments of the disclosed subject matter;

FIG. 8 is a screen shot/display showing images within an album according to aspects of embodiments of the disclosed subject matter;

FIG. 9 is a screen shot/display showing images in an album with a tool bard providing organization tools according to aspects of embodiments of the disclosed subject matter;

FIG. 10 is a screen shot/display showing the process of creating an album according to aspects of embodiments of the disclosed subject matter;

FIG. 11 is a screen shot/display showing information for a particular album according to aspects of embodiments of the disclosed subject matter;

FIG. 12 is a screen shot/display showing settings for an account according to aspects of embodiments of the disclosed subject matter;

FIG. 13 is a screen shot/display showing number of members in an album according to aspects of embodiments of the disclosed subject matter;

FIG. 14 is a screen shot/display showing storage amounts according to aspects of embodiments of the disclosed subject matter;

FIG. 15 is a screen shot/display showing photograph/video content selection for creating an album according to aspects of embodiments of the disclosed subject matter;

FIG. 16 is a screen shot/display showing “Timeline” sorting for creating an album according to aspects of embodiments of the disclosed subject matter;

FIG. 17 is a screen shot/display showing photograph/video content selection according to a “Discover” function for creating an album according to aspects of embodiments of the disclosed subject matter;

FIG. 18 is a screen shot/display showing photograph/video content selection according to a “Discover/Magic” function for creating an album according to aspects of embodiments of the disclosed subject matter;

FIG. 19 is a screen shot/display showing photograph/video content selection according to a Discover/Flashback” function for creating an album according to aspects of embodiments of the disclosed subject matter;

FIG. 20 is a screen shot/display showing an “Account Information” display according to aspects of embodiments of the disclosed subject matter;

FIG. 21 is a screen shot/display showing a “Camera Sync” function according to aspects of embodiments of the disclosed subject matter;

FIG. 22 is a screen shot/display showing a “Create/Import Albums” content selection for creating an album according to aspects of embodiments of the disclosed subject matter;

FIG. 23 is a screen shot/display showing a photograph/video content selection page for creating an album according to aspects of embodiments of the disclosed subject matter;

FIG. 24 is a screen shot/display showing photograph/video content selection for creating an album according to aspects of embodiments of the disclosed subject matter;

FIG. 25 is a screen shot/display showing a “Members Details” information display content useful for member selection for creating an album according to aspects of embodiments of the disclosed subject matter;

FIG. 26 is a screen shot/display showing photograph/video content members listing according to aspects of embodiments of the disclosed subject matter;

FIG. 27 is a screen shot/display showing an “Add Members” selection page for creating an album according to aspects of embodiments of the disclosed subject matter;

FIG. 28 is a screen shot/display showing a “Members Listing” for creating an album according to aspects of embodiments of the disclosed subject matter;

FIG. 29 is a screen shot/display showing a “Change Members” page for creating an album according to aspects of embodiments of the disclosed subject matter;

FIG. 30 is a screen shot/display showing a “Remove Member” page for creating an album according to aspects of embodiments of the disclosed subject matter;

FIG. 31 is a screen shot/display showing a “Members Creation” page for creating an album according to aspects of embodiments of the disclosed subject matter;

FIG. 32 is a screen shot/display showing photograph/video content selection page for creating an album according to aspects of embodiments of the disclosed subject matter;

FIG. 33 is a screen shot/display showing photograph/video content deletion page for creating an album according to aspects of embodiments of the disclosed subject matter; and

FIG. 34 is a flow showing an album and user removal process.

### DETAILED DESCRIPTION

### I. Computing Systems

The systems and methods described herein rely on a variety of computer systems, networks and/or digital devices for operation. In order to fully appreciate how the system operates, an understanding of suitable computing devices and systems is useful. The computing devices, systems and methods disclosed herein are enabled as a result of application via a suitable computing device.

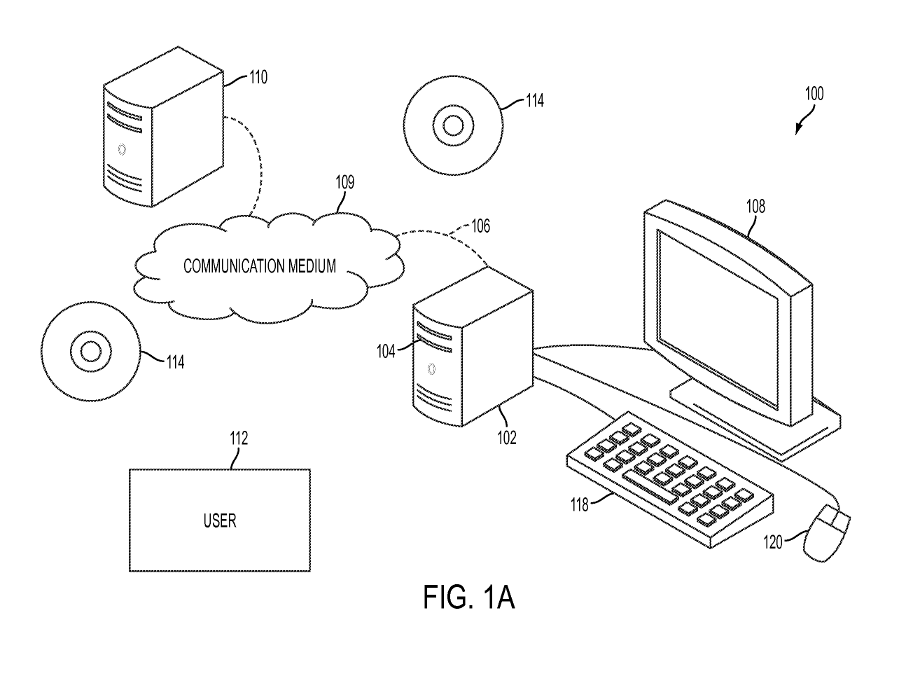

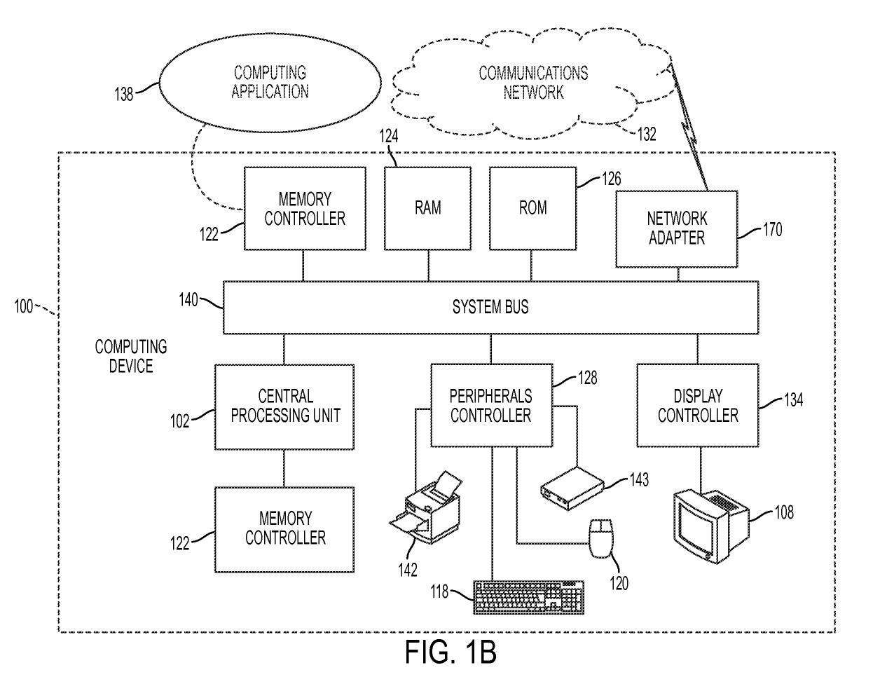

FIG. 1A is a block diagram showing a representative known example logic device through which a user 112 can, e.g., access a browser to implement the disclosed subject matter. A computer system (or computing device) 100, which may be understood as a logic apparatus adapted and configured to read instructions from media 114 and/or network port 106, is connectable to a server 110, and has a fixed media. The computer system 100 can also be connected to the Internet or an intranet. The system includes a central processing unit (CPU) 102, disk drives 104, optional input devices, illustrated as a keyboard 118 and/or mouse 120 and an optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present disclosure can be transmitted over such networks or connections. The computing device can be capable of, or in at least some situations adaptable for, communicating with a participant and/or a device used by a participant. The computer system is adaptable to communicate with other computers over the Internet, or with computers via a server.

FIG. 1B depicts another exemplary known computing device 100. The computing system (computing device) 100 is capable of, or in at least some situations adaptable for, executing a variety of computing applications 138, including computing applications, a computing applet, a computing program, or other instructions for operating on computing device 100 to perform at least one function, operation, and/or procedure. Computing device 100 is controllable by computer readable storage media for tangibly storing computer readable instructions, which may be in the form of software. The computer readable storage media capable of, or in at least some situations adaptable to, tangibly store computer readable instructions can contain instructions for computing device 100 for storing and accessing the computer readable storage media to read the instructions stored thereon themselves. Such software may be executed within CPU 102 to cause the computing device 100 to perform desired functions. In many known computer servers, workstations and personal computers, CPU 102 is implemented by micro-electronic chips (CPUs) called microprocessors. Optionally, a co-processor (not shown), distinct from the main CPU 102, can be provided that performs additional functions or assists the CPU 102. The CPU 102 may be connected to the co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for interpretation of code-containing signals. Computer readable storage media, as used herein, refers to physical or tangible storage (as opposed to transitory signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing device 100 can contain peripherals controller 128 responsible for communicating instructions from the CPU 102 to peripherals, such as, printer 142, keyboard 118, mouse 120, and data storage drive 143. Display 108, which is controlled by a display controller 134, is used to display visual output generated by the computing system 100. Such visual output may include text, graphics, animated graphics, and video. The display controller 134 includes electronic components required to generate a video signal that is sent to display 108. Further, the computing device 100 can contain network adaptor 136 which may be used to connect the computing device 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the disclosed subject matter. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

### III. Wireless Networks

Known wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; a display; one or more audio transducers (for example, a speaker or a microphone as in devices for audio communications); electromagnetic data storage (such as ROM, RAM, digital data storage, etc., such as in devices where data processing is provided); a memory; a flash memory; and/or a full chip set or integrated circuit and interfaces (such as a universal serial bus (USB), a coder-decoder (CODEC), a universal asynchronous receiver-transmitter (UART), a phase-change memory (PCM), etc.). Other components can be provided without departing from the scope of the disclosed subject matter.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device, i.e., a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000, or any other data transmission encoding or modulation. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

FIG. 1C depicts components that can be employed in known system configurations enabling the systems and technical effect of this disclosure, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver 160 in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172′ for communication to the access point 154. By way of example, in some embodiments an authenticator could be employed within such an access point (AP) and/or a supplicant or peer could be employed within a mobile node or user station. Display 108, 108′ and keyboard 118, 118′ or input devices can also be provided with the user stations 156, 156′.

### IV. Access Via Browser

In at least some configurations, a user executes a browser to view digital content items and can connect to the front end server via a network, which is typically the Internet, but can also be any network, including but not limited to any combination of a LAN, a MAN, a WAN, a mobile, wired or wireless network, a private network, or a virtual or ad hoc private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application capable of or adaptable to allowing access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

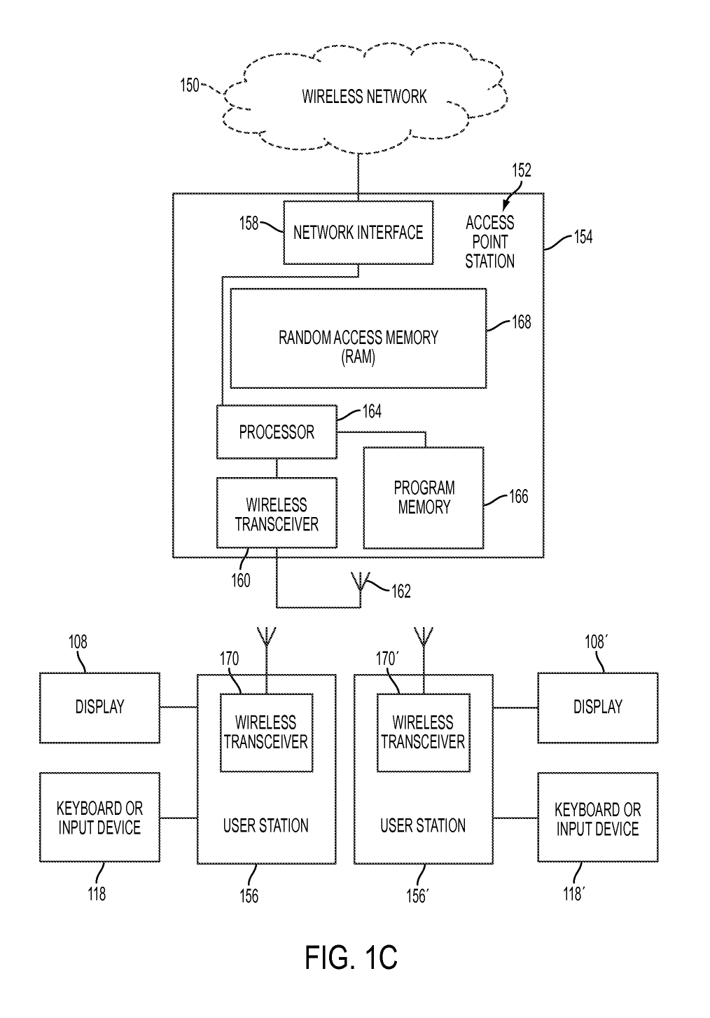

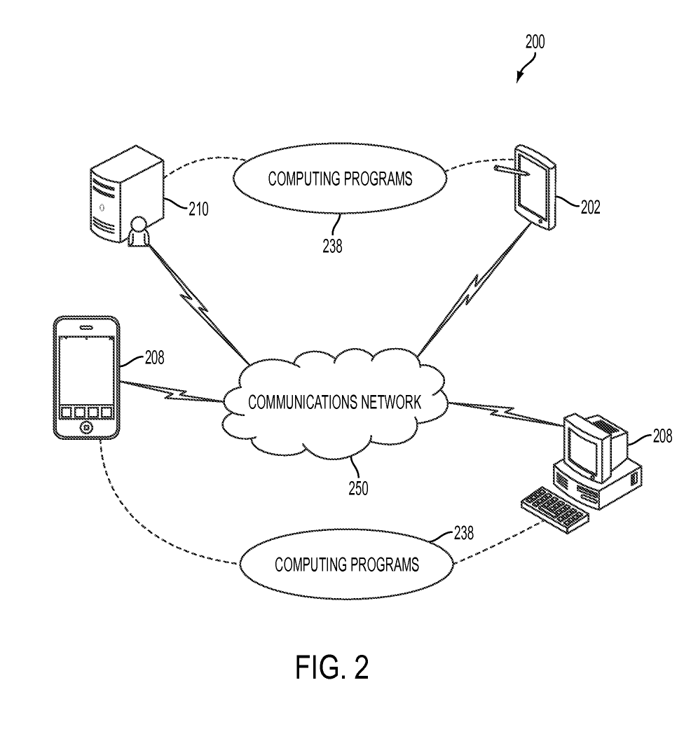

A computing device 100, described above, can be deployed as a computer network or part of a computer network used to achieve the desired technical effect and transformation. In general, the above description for computing environments applies to both server computers and client computers deployed in a network environment. FIG. 2 illustrates a known exemplary illustrative networked computing environment 200, with a server in communication with client computers via a communications network 250. As shown in FIG. 2, server 210 may be interconnected via a communications network 250 (which may be either of, or a combination of a fixed-wire or wireless LAN, WAN, intranet, extranet, peer-to-peer network, virtual or ad hoc private network, the Internet, or other communications network) with a number of client computing environments such as tablet personal computer 202, smart phone 204, personal computer 208, and personal digital assistant (not shown). In a network environment in which the communications network 250 is the Internet, for example, server 210 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 200 can utilize various data security protocols such as secured socket layer (SSL) or pretty good privacy (PGP). Each client computing environment can be equipped with operating system 238 operable to support one or more computing applications, such as a web browser (not shown), or other graphical user interface (not shown), or a mobile desktop environment (not shown) to gain access to server computing environment 200.

In operation, a user (not shown) may interact with a computing application running on a client computing environment to obtain desired data and/or computing applications. The data and/or computing applications may be stored on server computing environment 200 and communicated to cooperating users through client computing environments over exemplary communications network 250. The computing applications, described in more detail below, are used to achieve the desired technical effect and transformation set forth. A participating user may request access to specific data and applications housed in whole or in part on server computing environment 200. These data may be communicated between client computing environments and server computing environments for processing and storage. Server computing environment 200 may host computing applications, processes and applets for the generation, authentication, encryption, and communication of data and applications and may cooperate with other server computing environments (not shown), third party service providers (not shown), network attached storage (NAS) and storage area networks (SAN) to realize application/data transactions.

### V. Software Programs Implementable in the Computing and Network Environments to Achieve a Desired Technical Effect or Transformation

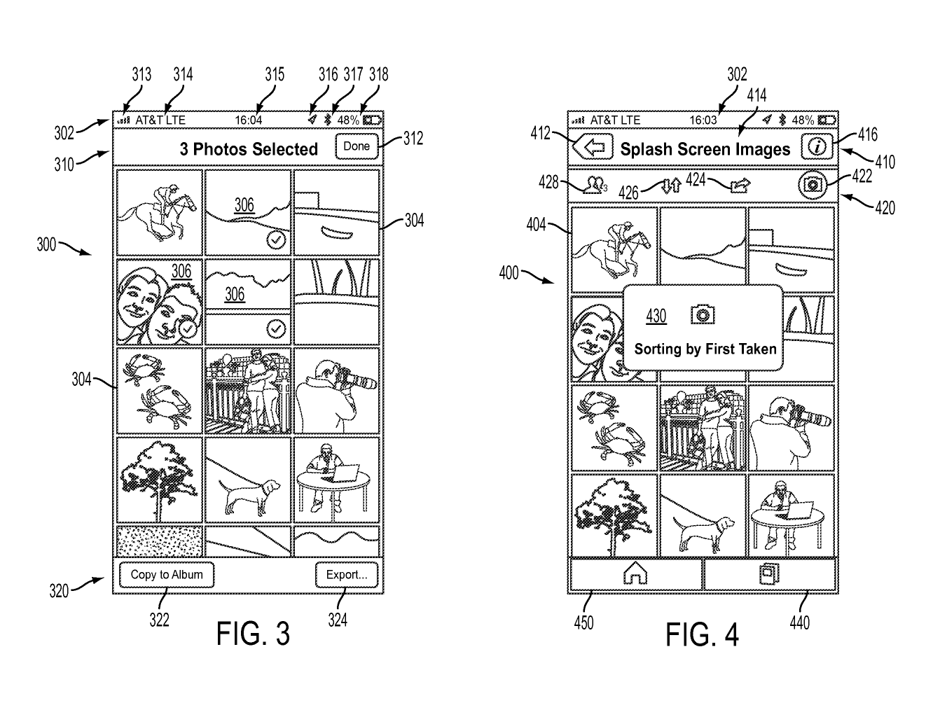

FIG. 3 is a screen shot 300 from a mobile device showing 12 images 304, and three selected images 306. The input photo selection screen display 300 may include a user device, e.g., a smartphone status bar 302, which may include, e.g., a signal reception indicator 313, a service provider LTE network available indicator 314, a time of day indicator 315, a location services in use indicator 316, a Bluetooth synchronizer available indicator 317, and a battery strength indicator 318. The screen display 300 may also include a status bar 310, with a “Photos Selected” indicator 314 and a “Done” button 312. A functionality bar 320 on the screen display 300 may include a “Copy to Album” button 322, for invoking a “Copy to Album” functionality and an “Export” button 324 to invoke an “Export” functionality.

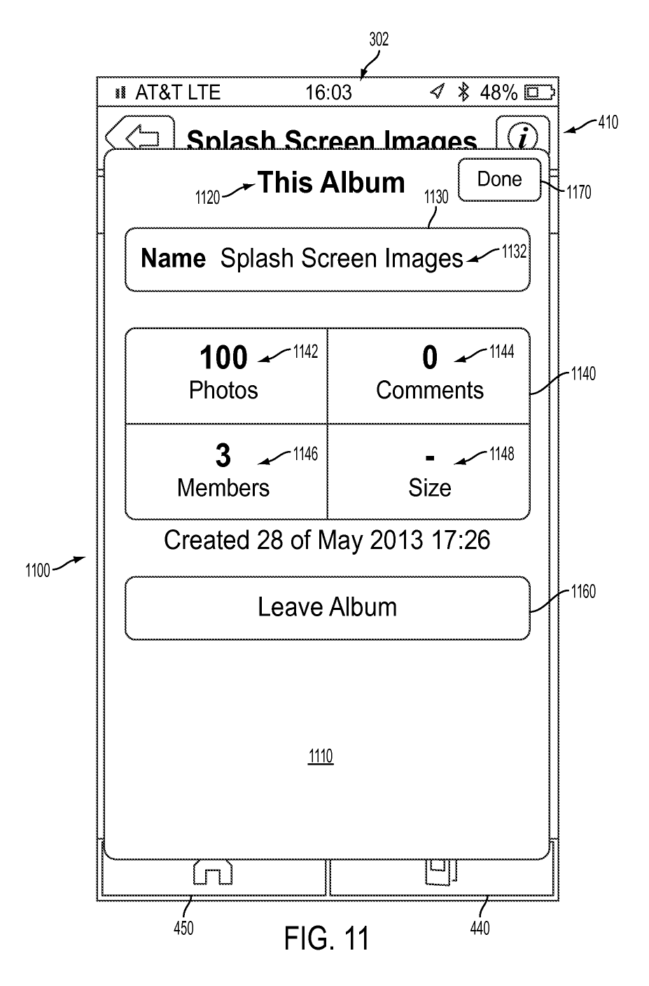

FIG. 4 is a screen display 400 showing a tool bar 420 which can enable a user to organize content, e.g., photographic images 404, e.g., by sorting by the date the image 404 was created. The album review and organization screen display 400, can included the sorted photos 404. The screen display 400 may also include an album selection tool bar 410, which may include an album selection button 412, an indication of the currently selected album title 414 “Splash Screen Images,” and an information selection button 416, for selecting a screen display, such as shown in FIG. 11, regarding information about the selected “Splash Screen Images” album. The screen display 400 may also include an organization activity functionality tool bar 420, which may include a camera select button 422 for selecting a camera on the currently used portable user computing/communication device, a forward photo to album button 424, a sort button 426 to select sorting criteria and a modify users list button 428. The screen display 400 may also include an activity indicator 430, e.g., indicating that the album is being sorted by first taken photos. The screen display 400 may also include an albums selection button 440 for selecting the list of albums and a home page selection button 450 for returning to the application home page.

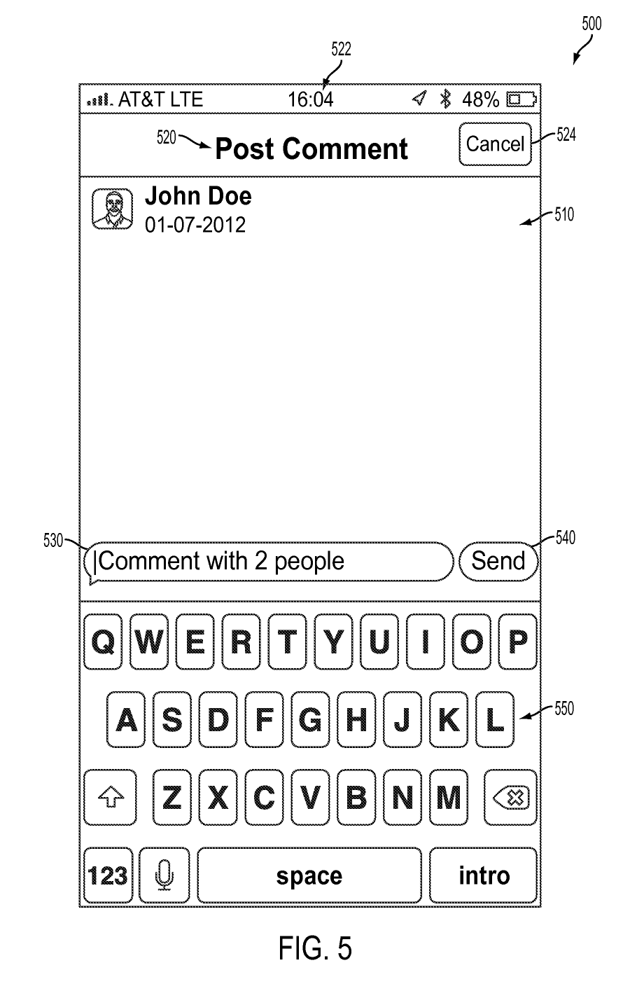

FIG. 5 is a screen display 500 showing a commenting function for the application. The screen display 500 may include, e.g., a user indicator tool bar 510, for indicating the present user accessing the application, i.e., “John Doe.” The screen display 500 may also include an activities tool bar 520, e.g., with a current page activity indicator 522, e.g., “Post Comment” and a cancel button 524. The screen display 500 may also include a comment test input entry display 530, indicating, e.g., before the entry of the comment text, that the comment is with two people, e.g., two other owners/members/curators of the album. The screen display 500 may also include a send comment button 540. Also included may be a virtual touch screen keyboard 550. It will be understood that in some embodiments, the user may be prompted to use a physical keyboard associated with the user's computing/communication device.

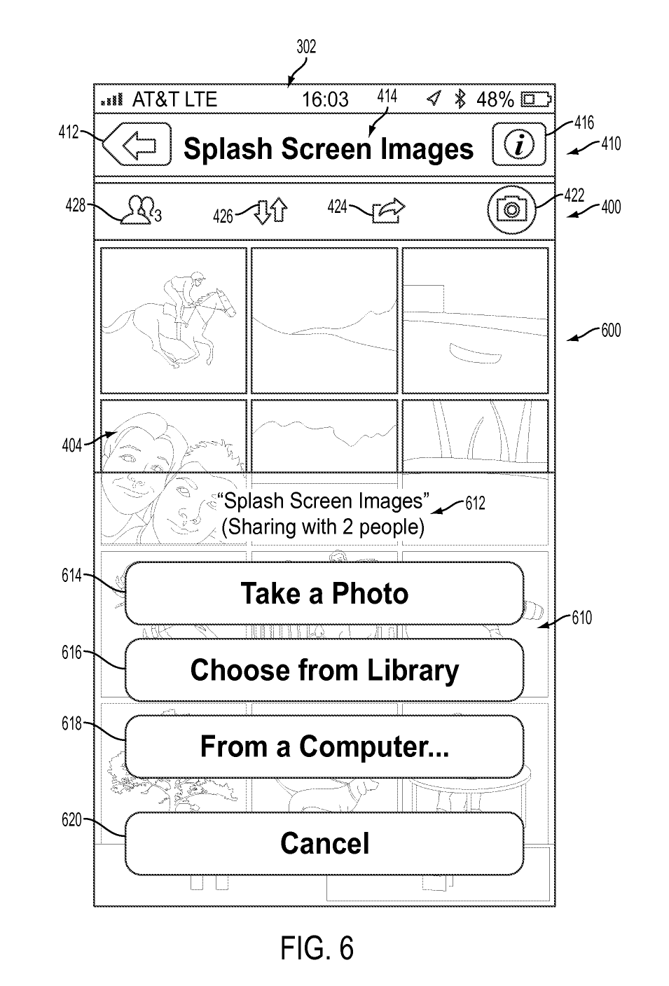

FIG. 6 is a screen display 600 showing a pop-up overlay 610 on the screen display 400 of FIG. 4, e.g., requesting further information from the user. The photo album photo input screen display 600 may include the photo input selection overlay 610, overlaying the album review screen display 400, and may include a status tool bar 612, e.g., indicating the selected album is “Splash Screen Images” and is currently being shared by the user with two people, e.g., the other two owners/members/curators of the album. The photo input selection overlay may include a “Take a Photo” button 614, a “Choose from Library” selection button 616, for selecting a photo from a library and a “From a Computer” selection button 618, for selecting a photo from a computer storage of the digital photo. Also included may be a “Cancel” button 620.

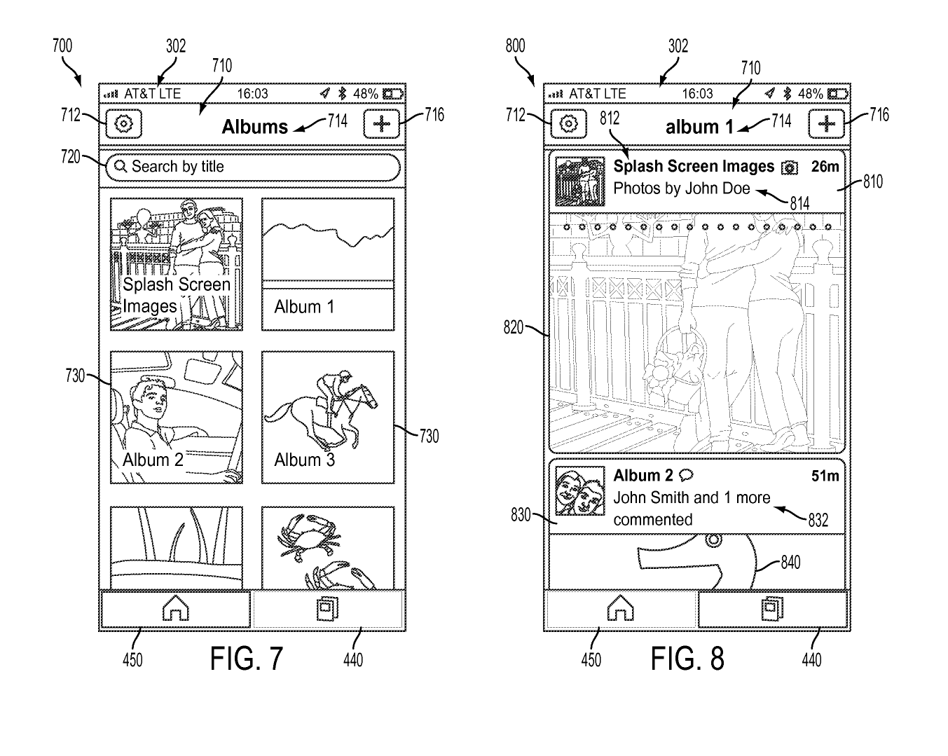

FIG. 7 is a screen display 700 showing a listing of albums. Album listing display screen 700 can have an activity selection tool bar 710, with a user settings information selection button 712, a current page title 714, e.g., “Albums” and an “add a new album” button 716. The screen display 700 may also include a search text input block 720. The screen display 700 may also include a display of album covers 730, with titles, which may include, e.g., the first photo in a given album.

FIG. 8 is a screen display 800 showing images within an album. The album information and selection button overlay 810, may indicate the album title 812, the album author or originator 814, and may appear over a generic photographic image, e.g., a wallpaper display 820. The screen display may also include a commenter participation test messaging selection button overlay 830, which may include a commenter identification 832. The screen display may also include an application provider logo, e.g., a seahorse logo 840.

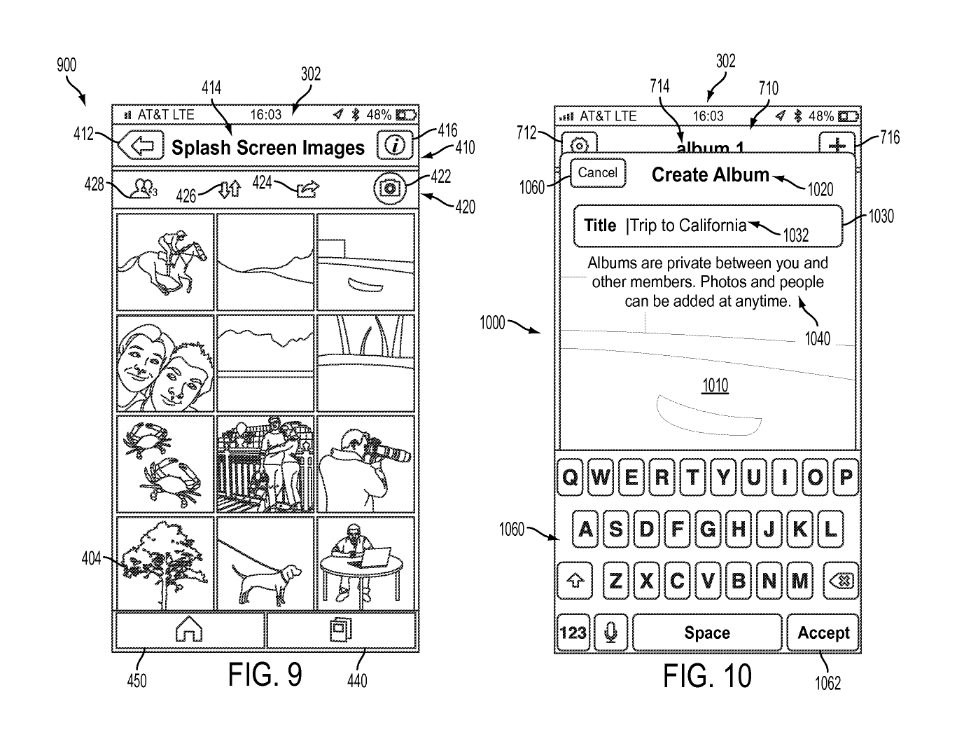

FIG. 9 is a screen display 900 showing images in an album with tool bars providing organization tools and other items discussed in regard to FIG. 4.

FIG. 10 is a screen display 1000 showing the process of creating an album. The album creation screen display 1000 can include an album creation overlay 1010, e.g., over the screen display 700 of FIG. 7, from which the screen display 1000 may have been selected using the “add a new album” button 716. The screen display 1000 may include an overlay 1010, which may have a “Create Album” title 1020, a title input entry text display 1030. The title entry text display 1030 may display a new title “Trip to California,” entered by the user. The overlay 1010 may also include information 1040, e.g., indicating that “Albums are private between you [the user] and other members. Photos and people can be added at any time.” The screen display 1000 may also include a virtual touch screen keyboard overlay 1060.

FIG. 11 is a screen shot showing information for a particular album. The album information presentation screen display 1100 may include an album information presentation overlay 1110, e.g., overlaying the screen display 400 of FIG. 4, from which it may have been selected using the album information selection button 416 of FIG. 4. The album overlay presentation overlay 1110 may have a title 1120, i.e., “This Album.” The screen display may have an album title display block 1130, e.g., displaying the selected album “Splash Screen Images.” The screen display pop-up overlay 1110 may also include album data blocks 1140, including, e.g., a number of photos block 1142, a number of comments block 1144, a number of members/owners of the album block 1146 and a storage size for existing album storage block 1148. Also included may be a creation date indication 1150 and a “Leave Album” button 1160.

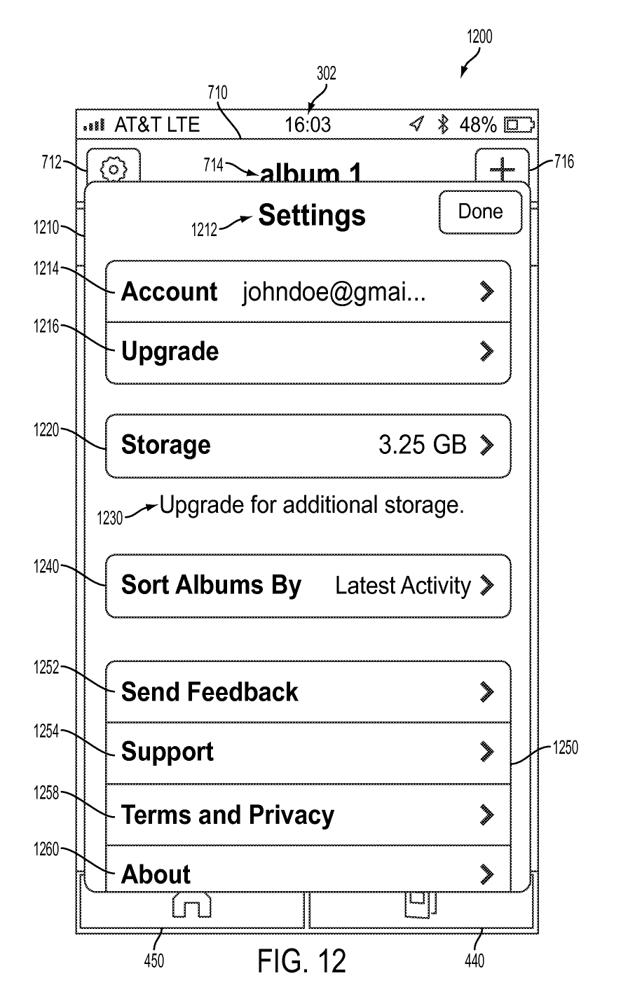

FIG. 12 is a screen display 1200 showing settings for an account. The settings screen display 1200 may include a user settings screen display overlay 1210, overlaying the screen display 700 of FIG. 7, from which it may have been selected using the user settings information section button 712. The overlay 1210 may have a “Settings” title 1212, an account identifier and selection button 1214 and an account upgrade selection button 1216. The overlay 1210 may also have a storage identifier and selection button 1220. The overlay 1210 may also include instructions 1230, e.g., “Upgrade for additional storage.” The overlay 1210 may also include a sort instructions identification and selection button 1240, e.g., for selecting how to sort albums, e.g., by “Latest Activity.” The overlay may also include an application provider communications block 1250, which may include a feedback input selection button 1252, a support selection button 1254, a terms and privacy policy selection button 1256 and an “about the provider” button 1260.

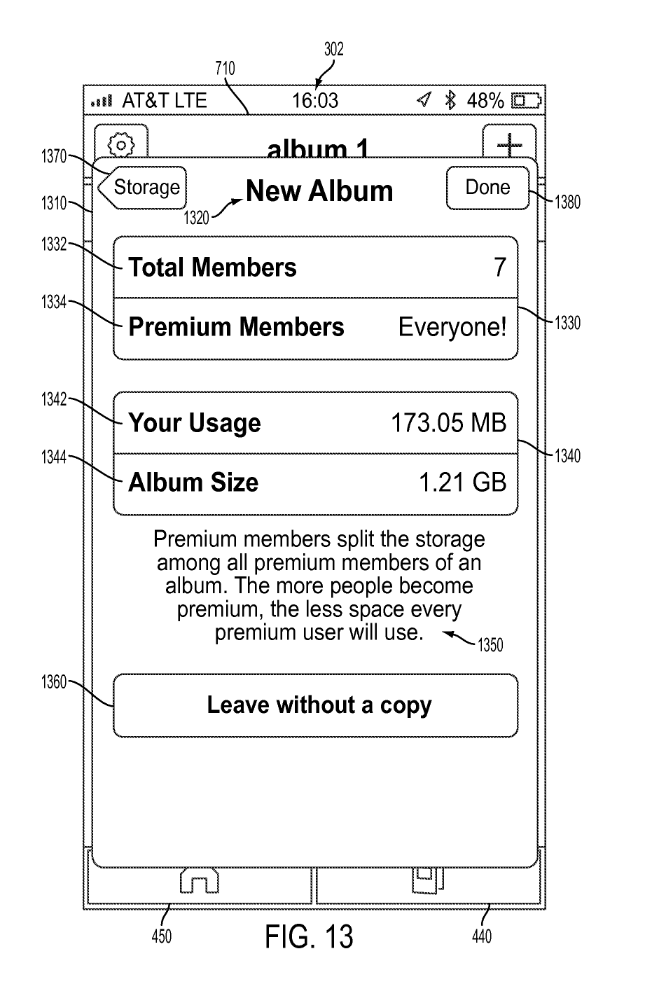

FIG. 13 is a screen display 1300 showing album storage for the number of members in an album. The album storage screen display 1300 can include, e.g., an album storage information pop-up overlay 1310 over the screen display 700 of FIG. 7, from which it may be accessed, utilizing an album selection button 730. The overlay 1310 can include an album title 1320. It may also include a members classification block 1330, which may indicate, e.g., total members 1332, i.e., 7 for the indicated album and premium members indication 1334. The overlay 1310 may also include a storage usage information block 1340, which can include user usage information 1342 and album storage usage information 1344, where the album storage usage 1.21 GB is the number of members (7) times the member's individual usage (173.05 MB). The overlay 1310 may also include information 1350, such as “Premium members s[lit the storage among all premium members of an album. The more people that become premium members, the less space every premium member will use.” The overlay 1310 may also include a “leave without a copy button” 1360, a storage selection button 1370 and a “Done” button 1380.

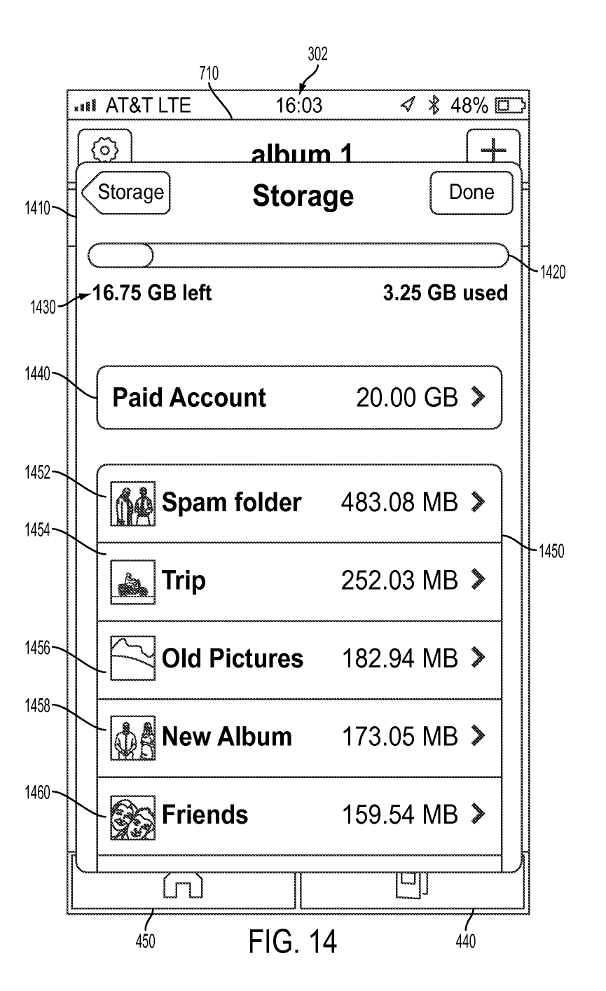

FIG. 14 is a screen display 1400 showing storage amounts. The screen display 1400 can include a storage amounts overlay 1410, overlaying the screen display of FIG. 7, from which it may be accessed using the “Storage” button 1220 on Screen display 1200. The overlay 1410 may include an overlay title “Storage” 1412. The overlay 1410 may also include a usage slide 1420, which may indicate the remaining storage 1430 (16.75 GB), based on the 3.25 GB already used, as being relatively small. The overlay 1410 may also include a paid amount indicator and selection button 1440, which may be utilized to access a page on which to buy more storage. The overlay 1410 may also include an album storage indicator and selection panel 1450, listing album 1452 “Spam folder . . . ,” 1454 “Trip . . . ,” 1456 “Old Pictures,” 1458 “New Album,” 1460 “Friends” and their respective storage usage amounts.

In using the system, a user creates an account, e.g., utilizing an account creation screen display (not shown). Once an account is created, the user can create an album, e.g., utilizing the album creation screen display 700 of FIG. 7, into which content (e.g., photos and videos) can be placed, e.g., utilizing the album creation screen displays 600 of FIGS. 6 and 300 of FIG. 3. Once the content is placed within an album other members of the album can be designated utilizing a member designation screen display (not shown) and thereby are granted a non-exclusive license to the content.

Once an album is created the creating user has full rights to manipulate the album including the ability to add additional members/users/curators. Once additional users are added to an album each of the added users can, e.g., have full access to the album. The system can be configured such that any user/member/curator having full access to an album can perform all functions associated with being a curator of the album including, but not limited to: adding photos, deleting photos, adding users, and deleting users. Thus, each album effectively has multiple owners. Additionally, each user has permanent access to the content of the album that existed at the time the user was added and thereafter until the user is deleted from the album.

Once a user is deleted from an album, all of the content of the album will be captured at that time and the deleted user will continue to have access to the content of the album as of the time that user was removed as a user of the album. The system can be configured such that the multiple owners can equally share the cost of hosting the data associated with the album.

Each album created by an individual user can have different qualities, including persons having access to the albums. Albums need not be publicly available beyond the users that share ownership of the albums. Additionally, the cost for hosting each album can have different qualities depending upon the number of users/members/curators/collaborators, etc.

FIG. 15 is a screen shot/display 1500 showing photograph/video content selection for creating an album according to aspects of embodiments of the disclosed subject matter. The content entry screen display 1500 can include, e.g., a photograph 1502, which could be an album cover. The screen display 1500 can also indicate the person inputting the photograph 1504, e.g., “Matt Martin.” The screen display 1500 can also indicate at 1510 that individuals such as August Herman, Christopher Owens and Jose Nash “liked” the content. The screen display 1500 can also contain, as examples, a functions selection bar 1520, which can include, e.g., a “News” button 1522; a “Timeline” button 1524; a “Discover” button 1526 and an “Albums” button. A “album 1” application title 1560 may also be displayed. A user ID icon 1550 may also be displayed. Access to a “News” feed using the “News” button 1522 is as is well known in the art.

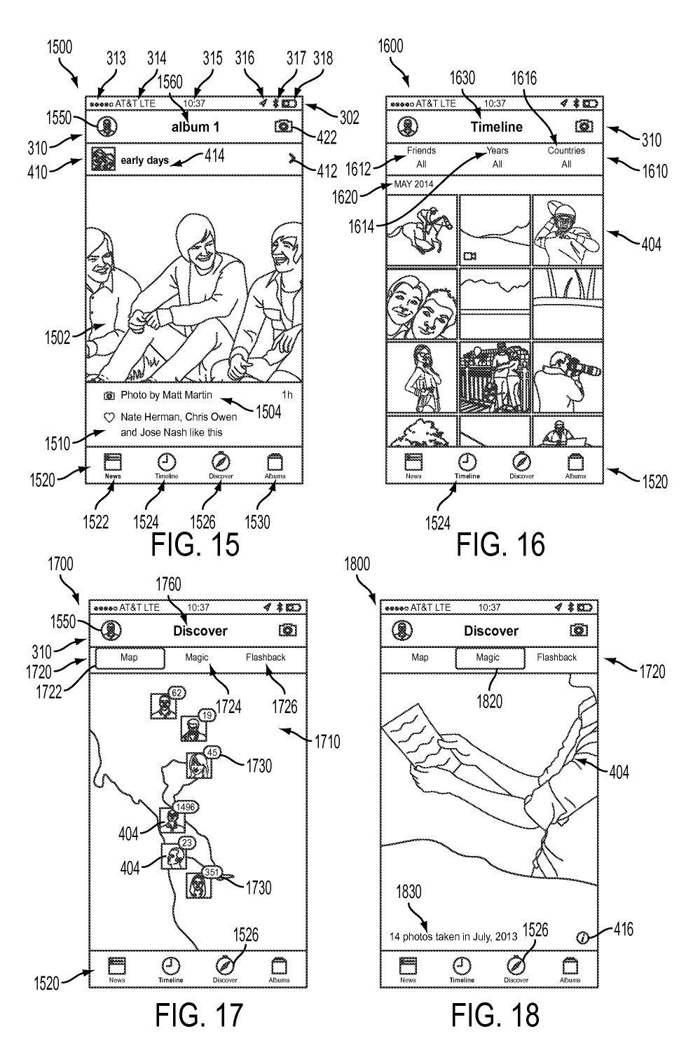

FIG. 16 is a screen shot/display 1600 showing “Timeline” sorting for creating an album according to aspects of embodiments of the disclosed subject matter, which may be selected from the screen display 1500 of FIG. 15, which may be selected using the “Timeline” button 1524 in the screen display 1500. The “Timeline” screen display 1600 may include a sorting actions bar 1610. The sorting actions selection bar 1610 may include, as examples, a “sort by friends” button 1612, a “sort by years” button 1614 and a sort by countries button 1616. The screen display 1600 may also include a “Timeline” title 1630, and a date indicator 1620. It will be understood that the user can scroll down by dragging a finger of the user across the screen display 1600 to uncover additional photos/video content 404. “Timeline” access can utilize, e.g., filters, and can, e.g., find Media rather than albums, though access to a given media may provide access to or information for obtaining access to a given album.

FIG. 17 is a screen shot/display 1700 showing photograph/video content selection according to a “Discover” function for creating an album according to aspects of embodiments of the disclosed subject matter. The screen display 1700 may include a map 1710 which may be utilized, e.g., to display a geographic location of where a photo 404 was taken, e.g., including a photo identification number 1730, e.g., a number of the photograph on a contributing member/collaborator's digital photo roll. The screen display may also include, by way of example, a “Discover” actions selection bar 1720, which may include, e.g., a “Map” selection button 1722, a “Magic” selection button 1724 and a “Flashback” selection button 1726. With the “Map” selection button 1722 activated, as well as the “Discover” selection button 1526 having been selected, as indicated in screen display 1700, as noted above, the map 1710 can be displayed, showing the geographic locations for the original taking of the photo/video content 404 and the photo ID numbers 1730. A “Discover” screen title 1760 may also be displayed.

FIG. 18 is a screen shot/display 1800 showing photograph/video content selection according to a “Discover” function for creating an album according to aspects of embodiments of the disclosed subject matter. The “Discover” screen display 1800 may include, e.g., a “Map” selection button 1802 for accessing the “Map” screen display 1700 and a “Magic” selection button 1820, which when selected can provide for a random sorting of photos, e.g. randomly returning content in the form of a photograph having been taken on a randomly selected date or in a randomly selected time period 1830, e.g., “14 photos taken in July, 2013.”

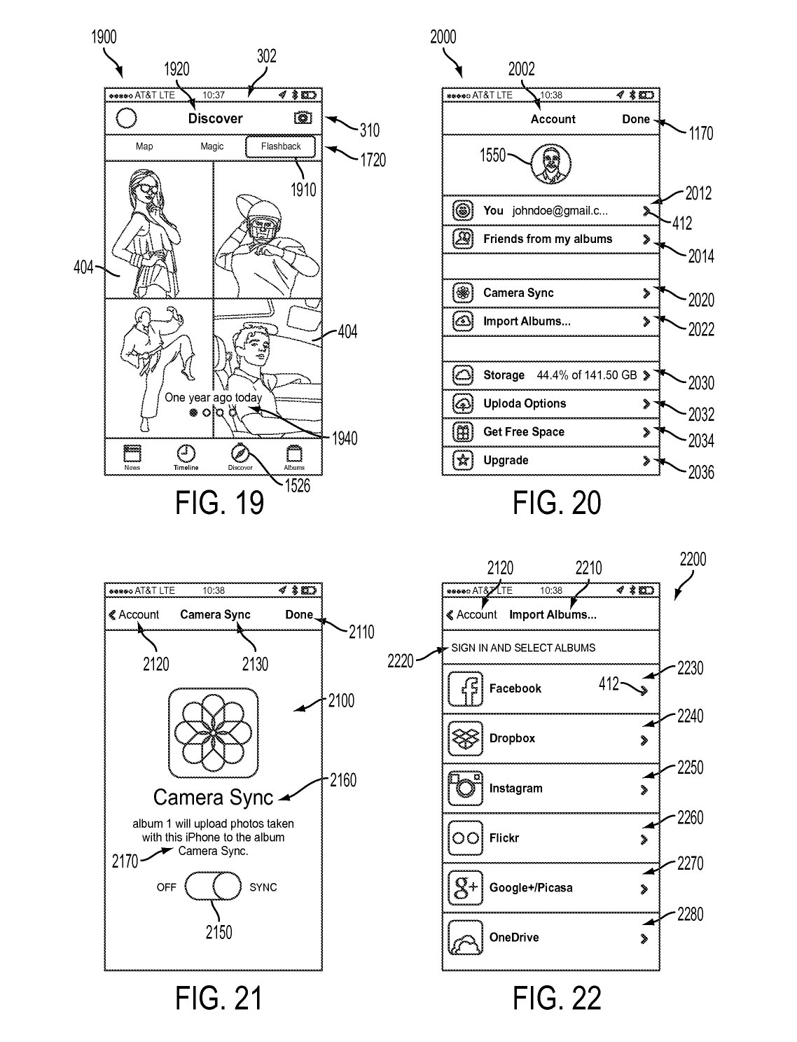

FIG. 19 is a screen shot/display 1900 showing photograph/video content selection according to a Discover/Flashback” function for creating an album according to aspects of embodiments of the disclosed subject matter. The “Discover Flashback” screen display 1900 can include, e.g., a “Flashback” selection button 1910 and a “Discover” title 1920. A text box 1940 may include a sorting ID text 1940, e.g., indicating the photograph(s)/other video content was selected for having been created one year earlier. As noted above, the screen display 1900 also indicates that the “Discover” button 1526 and “Flashback” button 1720 have been selected. It will be understood that the user can scroll down by dragging a finger of the user across the screen display 1900 to uncover additional photos/video content 404.

FIG. 20 is a screen shot/display 2000 showing an “Account Information” display according to aspects of embodiments of the disclosed subject matter. The “Account” information screen display 2000 can have an “Account” title 2002. The screen display may also include an account information and/or options selection menu 2010, which may include, as examples, a user identification information selection button 2012 and a friends selection button 2014. The screen display 2000 may also include, e.g., a “Camera Sync” selection button 2020 and an “Import Albums” selection button 2022. A “Storage Information” selection button 2030 may indicate available storage remaining An “Upload Options” selection button 2032 may be utilized to select uploads. A “Get Free Space” information selection button 2034 may be utilized to select information regarding ways for a user to get additional storage space for free. An “Upgrade” information selection button 2036 may be utilized to allow the user to select available upgrades. It will be understood that the user can scroll down by dragging a finger of the user across the screen display 2000 to uncover additional possible account information selection buttons on the selection 2010.

FIG. 21 is a screen shot/display 2100 showing a “Camera Sync” function according to aspects of embodiments of the disclosed subject matter. The “Camera Sync” function may be selected by utilizing the “Camera Sync” button 2020 in screen display 2000. The screen display 2100 may have an Account information screen selection button 2120 for returning to the “Account Information” screen display 2000. The “Camera Sync” screen display 2100 may have a “Camera Sync” title 2130. The “Camera Sync” screen display 2100 may also include a sync on/off selector 2150. The screen display may also indicate that “Camera Sync” is on by displaying a “Camera Sync” function indicator and logo 2160, e.g., with a text block 2170 indicating that “Album 1 will up-load photos taken with this iPhone to the album “Camera Sync.” “Camera Sync” may be utilized to, e.g., upload content from other media, e.g., into an album, as is known in the art.

FIG. 22 is a screen shot/display 2200 showing a “Create/Import Albums” content import selection for creating an album according to aspects of embodiments of the disclosed subject matter. The screen display may also have a return to “Account Information” page selection button 2120. The screen display may include a “Create/Import albums” title 2210 and a “Sign In and Select Albums” button 2220. With the “Sign In and Select Albums” button 2220 activated, e.g., the application may display on the screen display 2200 various sources, e.g., a “Facebook”® selection button 2230, a “Dropbox”™ selection button 2240, an “Instagram”™ selection button 2250, a “Flickr”™ selection button 2260, a “Google”® and “Picasa”™ selection button 2270 and a “One Drive”™ selection button 2280. These may be utilized to upload photographs and other video contend from as respective one of the content storage applications. It will be understood that the can scroll down, e.g., by dragging a finger by the user across the screen display 2200 to uncover additional content storage location apps.

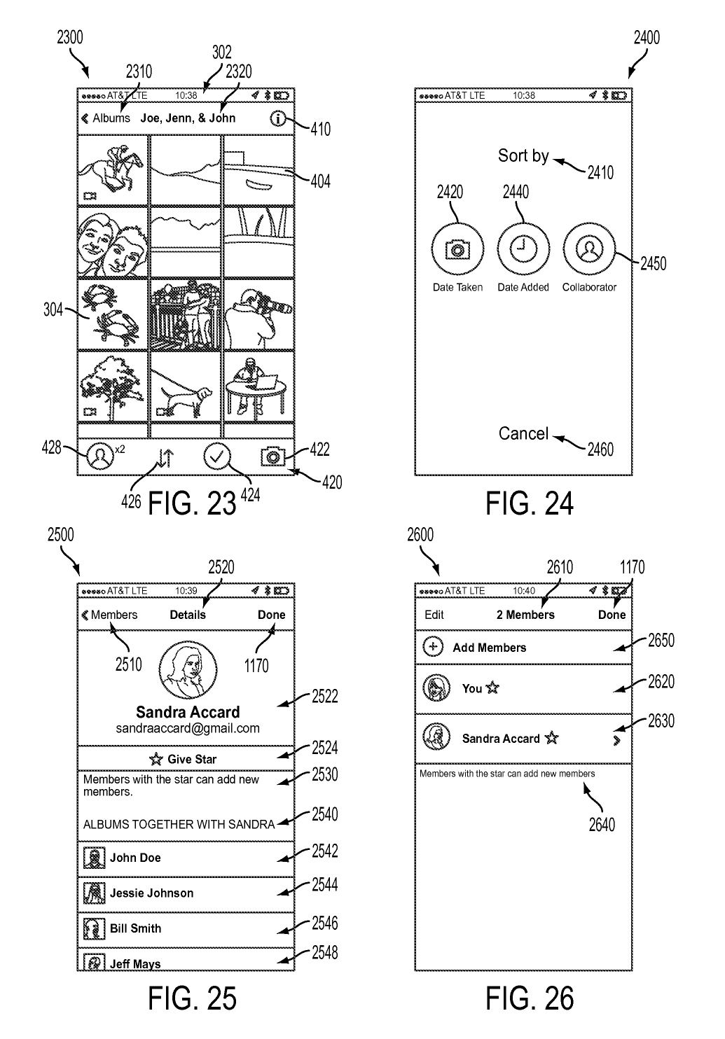

FIG. 23 is a screen shot/display 2300 showing a photograph/video content selection page for creating an album according to aspects of embodiments of the disclosed subject matter. The photo selection screen display 2300 may include an “Albums” creation/importation page return button 2310 to return to the screen display 2200. The Screen display 2300 may also include an album title 2320. It will be understood that the user can scroll down by dragging a finger of the user across the screen display 2300 to uncover additional photos/video content 304 for selection as content sorted to be an album entry 404. The screen display 2300 may also include the title 2320 of an album currently being selected and/or edited. Clicking on or similar touch screen selection of an individual photograph 304 will open the content to a full screen version, known in the art as a “gallery” view.

FIG. 24 is a screen shot/display 2400 showing photograph/video content selection for creating an album according to aspects of embodiments of the disclosed subject matter. “Sort” action page screen display 2400. The screen display 2400 may include a “Sort by” selection button 2410, a “Sort by” date of picture taking selection button 2420, a “Sort by” date added to an album selection button 2440 and a “Sort by” collaborator/member button 2450. Utilizing these sorting tools, by selection of the appropriate “Sort by” button on the screen display 2400, the user may select content to include into an album. The screen display 2400 may also include a cancel sorting button 2460. Media may be sorted, e.g., within an album. Other sorting criteria may also be utilized.

FIG. 25 is a screen shot/display 2500 showing a “Member Details” information display content useful for member selection for creating an album according to aspects of embodiments of the disclosed subject matter. member details information screen display 2500. The “Member Details” screen display 2500 may have a “Members” screen display 2400 selection button 2510 to return to the “Members” page, such as shown in the screen display 2800 of FIG. 28. The screen display 2500 may also include a “Members Details” page title 2520. A member ID information block 2522 may include, e.g., a photo of member a, such as, “Sandra Accord” with an email address “saccord@gmail.com.” The “Details” screen display 2500 may also include a “give a star” selection button 2524, e.g., for the user to add a member to an album with a star, indicating, as noted above, the ability to add or subtract other members. An information text box 2530 may be included, e.g., containing the text “Members with the star can add new members.” The screen display 2500 may also indicate “Albums together with Sandra” selection button 2540, which if activated may produce on the screen display 2500 a listing of albums on which both “Sandra” and another noted member(s) are collaborators, e.g., listings with “John Doe” 2542, “Jessie Johnson” 2544, “Bill Smith” 2546 and so on for the 2548. It will again be understood that scrolling may reveal additional such albums. The screen display 2500 may also be utilized to indicate albums that a user has with another user/member, e.g., Sandra Accard”. Such may be utilized to share memories with such other member/user and/or to collect, e.g., a “Memory Graph,” given the shared albums and also such other things as time, content, etc., e.g., by defining user connections and other filters.

FIG. 26 is a screen shot/display 2600 showing photograph/video content members listings according to aspects of embodiments of the disclosed subject matter. The “Album members listing” screen display 2600 may show, e.g., that, according to a “2 Members” title 2610, there are two members for the respective album, e.g., the user indicated by the user ID 2620, and an “Additional Member” listing 2630 for “Sandra Accard.” The screen display can then have a text block 2640, e.g., indicating that “Members with the star can add mew members.” Members with a star can add or drop members from an album. The originating member creator of an originating member-created album gets a star and can decide who else gets a star, and from there additional members can be added with stars or removed from an album.

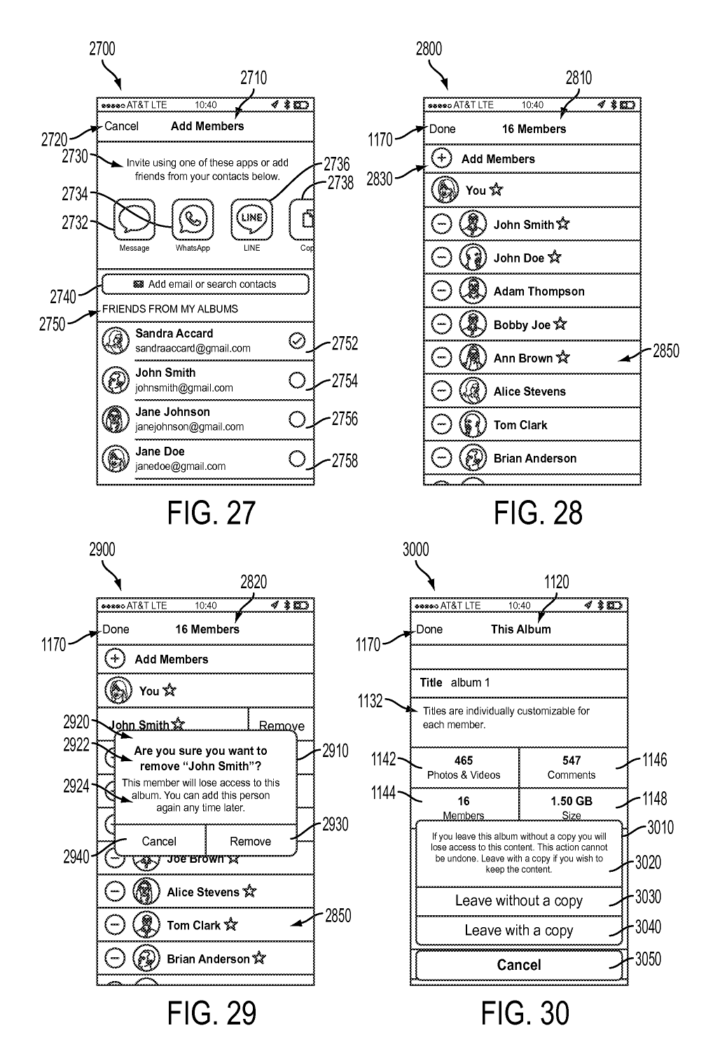

FIG. 27 is a screen shot/display 2700 showing an “Add Members” selection page for creating an album according to aspects of embodiments of the disclosed subject matter. The “Add Members” screen display 2700 can display an “Add Members” title 2710. The screen display 2700 may also include a “Cancel” button 2720. The screen display 2700 may be utilized to invite new members to, e.g., join an album. Also displayed can be an instruction test block 2730 with “Invite using one of these apps or add friends from your contacts below.” A “Messages” selection button 2732, a “WhatsApp”™ selection button 2734, a “Line”™ selection button 2736, and a “Copy File” selection button 2738, as examples, can be used to select apps for sending messages to other users, e.g., friends of a member. An “Add E-mail or Search Contacts” selection button 2740 can be utilized, e.g., for the user to activate a friend from a “Friends from My Albums” listing, including, as examples “Sandra Accard” 2752, “John Smith” 2754, “Jane Johnson” 2756 and “Jane Doe,” 2758. As noted above, it will be understood that scrolling down on the listing can display the names of other friends.

FIG. 28 is a screen shot/display 2800 showing a “Members Listing” for creating an album according to aspects of embodiments of the disclosed subject matter. The “Members Listing” screen display 2800 can include, e.g., an “Add Members” selection button 2830 for the user to be able to add new members to the “Members Listing” 2850, with members already listed, e.g., including “John Smith,” “John Doe,” “Adam Thompson,” “Bobby Joe,” “Ann Brown,” “Alice Stevens,” “Tom Clark,” Brian Anderson,” etc. Once again scrolling down on the listing can display more members. According to aspects of embodiments of the disclosed subject matter members with a star can remove other members on the listing, perhaps with some exceptions, e.g., other members with a star.

FIG. 29 is a screen shot/display 2900 showing a “Change Members” page for creating an album according to aspects of embodiments of the disclosed subject matter. The “Change Members” screen display 2900 can include a “Change Member” pop-up 2910, including, e.g., a “Change Member” text box 2920, which can display, e.g., a question 2922, such as, “Are you sure you want to remove “John Smith?” An instruction text can include an instruction 2924, such as, “This member will lose access to this album. You can add this person at any time later.” The screen display 2900 can also include, as an example, a “Remove” button 2930, which can be used to remove a member from the listing 2850 and a “Cancel” button 2940, to cancel the selection of a member for removal. A removed member may be notified that he/she will lose further access to the album, but not the content as of being removed. The removed member may, e.g., gets a copy, but is removed as a member with a star. The removed member can, therefore, no longer invite other members to join the album. The removed user/member can make a copy with all of the likes and comments, etc. up to the point of removal and, this can preserve the future privacy of other album members.

FIG. 30 is a screen shot/display 3000 showing a “Removed Member” information page for creating an album according to aspects of embodiments of the disclosed subject matter. The “Removed Member” information page screen display 3000 can be provided to the member being removed on the member's portable communications/computing device, and may include an instructions text box 3010, with, e.g., the text “If you leave this album without a copy you will lose access to this content. This action cannot be undone. Leave with a copy if you wish to keep the content.” Selection buttons 3020 may be displayed on the screen display 3000, e.g., a “Leave Without a Copy” button 3030, a “Leave With a Copy” button 3040 and a “Cancel” button 3050, for the member to cancel the pending removal transaction. The screen display 3000 may also display to the member being removed information about the album in question with a title “This Album” and similar to the page displayed in the screen display 1100 of FIG. 11.

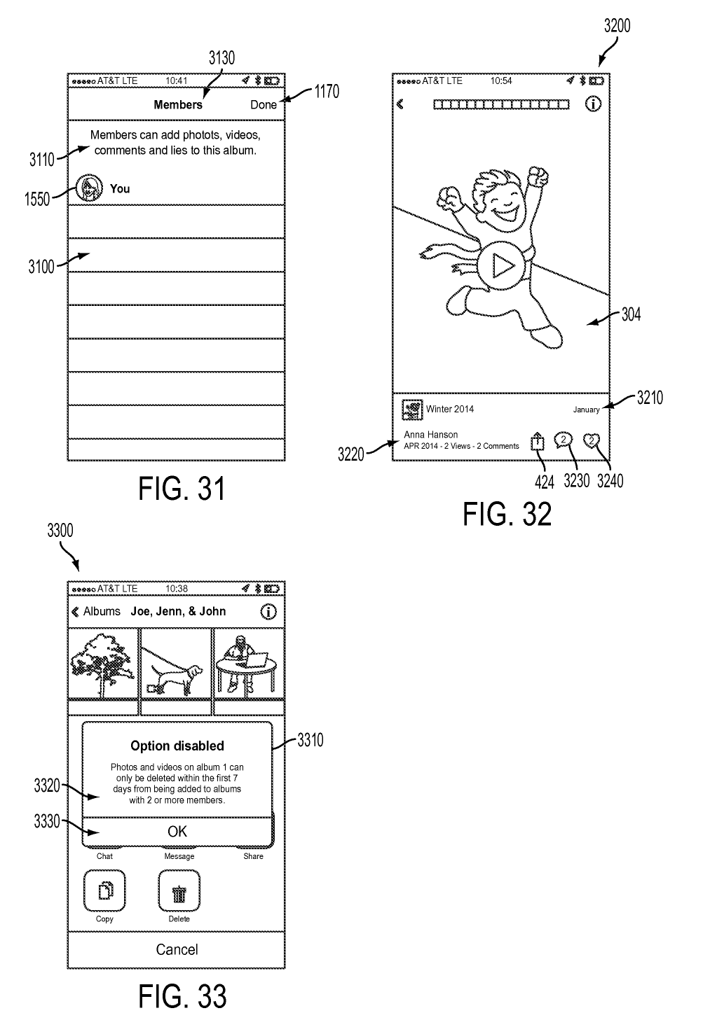

FIG. 31 is a screen shot/display 3100 showing, by way of example, a “Members Creation” page for creating an album according to aspects of embodiments of the disclosed subject matter. The “Members Creation” page screen display 3100 can include an instruction text box 3110 with the instructions “Members can adds photos, videos, comments and the like to this album.” The screen display 3100 can also include a “Members” title 3130. As shown in FIG. 31, access to a currently selected album is only to the user and without a star, e.g., which would be the case after a user/member is removed as a member from an album. As such the user leaves with a copy but is no longer a member with a star and only can continue to access the album as copied, i.e., this particular copy kept when removed as a member with a star.

FIG. 32 is a screen shot/display 3200 showing, as an example, a photograph/video content selection page for creating an album according to aspects of embodiments of the disclosed subject matter. The “Photo/Video entry” page screen display 3200, can be somewhat similar to the screen display 300 of FIG. 3, can include, e.g., an album identifier 3210, which may include an “Album Title” indicator 3212 and an “Album Creator” 3220, for the user to use in identifying an album, e.g., from a creator “Anna Hanson. The screen display may also include a comments indicator 3230, which may be utilized to indicate, e.g., that a certain number of individuals have commented on the album and a “likes” indicator 3240, for indicating the number of “likes” for the album. When opening a gallery, i.e., a full page display of a piece of content, e.g., from the “Timeline” screen 1600 or “Discover” screen 1800 one can get access to some selected content. The content could be a motion video as shown, which can also be indicated to be content from an album entitled “Winter 2014” created by “Anna Hanson,” and that it is actually in three different albums. This “Timeline” screen 1600, as an example, can be utilized to tap a particular content indicator, e.g., a photograph, to select, e.g., one of the other pieces of content in another album, which may be in a different language, e.g., for the purposes of making comments. It will be understood that users can have thousands of pieces of content in thousands of albums created with other members and more thousands that the user has been invited to join. These pieces of content can be found by sorting, e.g., by person, time, place, subject matter, etc. and then selecting the particular piece of video content can lead to the identification of the album(s) it was in and to information about the album(s). This can also be done by the pure random or magic selection functions to randomly access a piece of content, and through it other album content, e.g., from various media.

FIG. 33 is a screen shot/display 3300 showing an example of a photograph/video content deletion page for creating an album according to aspects of embodiments of the disclosed subject matter. The content deletion page screen display 3300 can include an “Option disabled” pop-up 3310. The “option disabled” pop-up can include an information text box 3320, with the text, e.g., “Photos and videos on Seahorse can only be deleted within the first seven (7) days of being added to albums with two or more members.” This content removal grace period functionality can be utilized to preserve the content in created albums, while allowing some period of time for a user posting content to remove the content that the user may subsequently feel might be inappropriate for some reason. Again this may, e.g., only be made available to the one posting the content and only briefly, otherwise content in created albums can be removed without question after an album has been in existence more than the selected time, e.g., seven days, and has more than one user/member/collaborator. The user can then select the “OK” button 3330, to carry out the removal or accede to the noted prohibition.

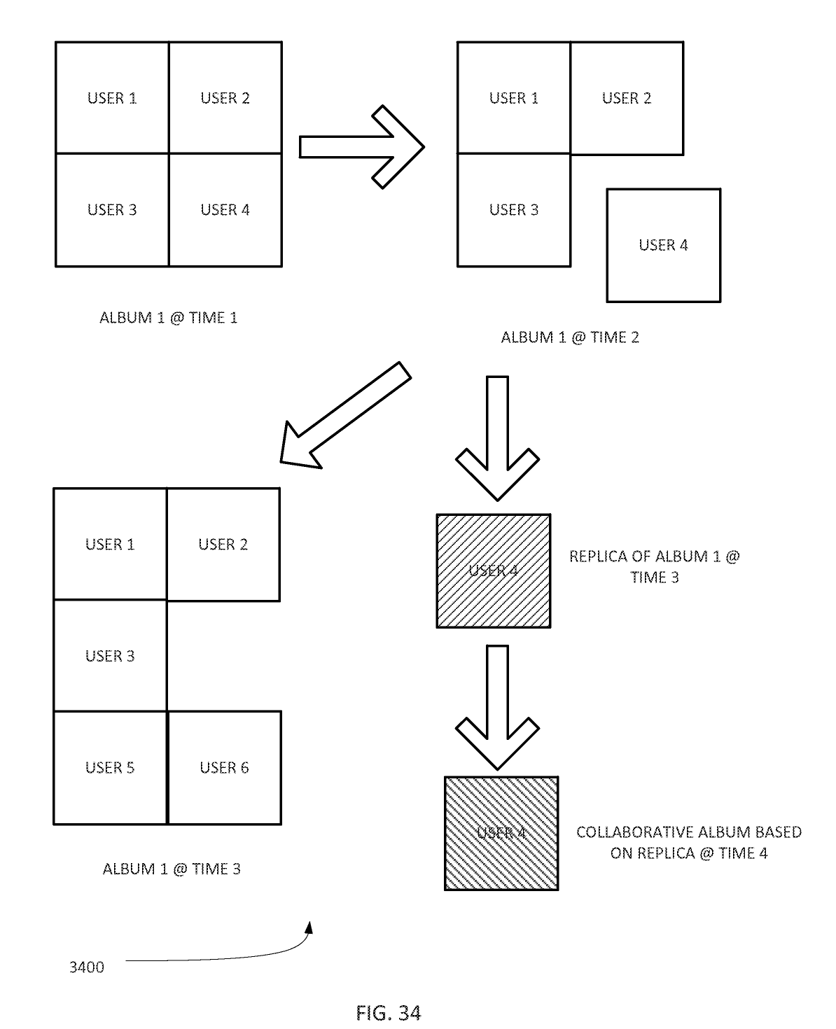

Turning to FIG. 34, the system 3400 is configurable to allow any user to add content, such as photos and videos, to a folder or album of which they are a member. For example, Album 1 at Time 1 can have four users (User 1, User 2, User 3, and User 4). User 1, for purposes of illustration would have a “star” as the first user creating the album. User 1 could then identify any (or none) of the other three users as a star. Each star user could, in turn, designate other star users. Each user can also load content into the album shared by all the users. Once a member has a star in a folder, that user's privileges associated with a star cannot be removed by the user or by other members of the folder. Starred users have increased privileges with respect to the folder. Increased privileges include, for example, adding and removing users, identifying users as having increased privileges.

The system is also configurable to provide a variety of grace periods that are for a definable period of time. During a grace period, a user that is removed may not obtain a replica of the folder if that user is removed, or a user may not have access to content that is removed during the grace period. During the content grace period, any user can remove content from a folder for which they are a member for a definable period of time, or grace period. After that the definable period of time allowing removable, content cannot be removed by anyone from the folder. A definable period of time could be, for example, 1 day, 5 days, 7 days, etc. When content is removed from a folder, the system is configurable such that the uploading user can still access the removed content (e.g, if a user adds a photo another user does not like, even if the photo is removed from everyone in the folder, the user who uploaded the photo can still access it. During the user grace period, the user that is removed cannot obtain a replica of the folder from which the user is removed.

As shown at time 2, when a member of a folder (such as User 4), with or without star in the source folder, is removed by another member with a star, that removed user gets a replica of the album that captures all of the content in the album as of the date and time the user was removed. This replica includes all content (photos, videos), as well as comments and meta data. Whether the removed member had a star or not when removed does not matter as the replica folder will not grant the user with star privileges to the content in the replica folder. Additionally, the removed user with the replica folder cannot invite other users to the folder (because the removed user does not have the enhanced privileges associated with a star). Additionally, any copies of content from the replica folder, such as the collaborative album based on replica at time 4, will remove all comments and meta data from the content. Thus, the user can copy the content to another album, and share the content with new people (such as Users 7 and 8), but the user cannot invite new people to the replica folder or share the social context of the content in the replica folder with others. When a user voluntarily leaves an album, the user can choose to leave with or without a copy (replica). The same rules apply to the replica for a user that voluntary leaves as though the user been removed. The grace period for removing content from a folder, also applies to the removal of members from a folder. If a user leaves or is removed from a folder within a definable period of time, e.g., 7 days, the departing user does not get a replica.

Album 1, at Time 3, illustrates the addition of new members to the Album after the removal of User 4.

It will be understood that a method and apparatus is disclosed for managing the video content of a network-based shared folder which may comprise creating, via a user computing device having Internet access, an originating member-created folder; selecting, via the user computing device, originating member selected video content and incorporating the originating member selected video content into the originating member-created folder; designating, via the user computing device, at least one other user as a member collaborating in the management of the video content kept in the originating member-created folder to the same extent as the originating member, for the video content kept in the originating member-created folder at the time of the designation of the at least one other member and up until the at least one other originating member-created folder comprising selecting video content to place into or remove from the originating member-created folder. Acting as a member of the originating member-created folder may comprise selecting an additional member to add to the or delete from the video content in the originating member-created folder and may comprise being selected by the originating member as a starred member for the originating member-created folder and having the ability to select an additional starred member for the originating member-created folder. Each folder may remain private to the existing members of the folder. The apparatus and method may comprise preventing any member of an originating member-created folder having more than one member from deleting video content from the folder after the passage of a selected relatively short period of time.

A machine readable medium storing instructions that, when executed by a computing device, cause the computing device to perform a method for managing the video content of a network-based shared folder, is also disclosed, where the method may comprise creating a network-based originating member-created folder; selecting originating member selected video content and incorporating the originating member selected video content into the originating member-created folder; and designating at least one other user as a member collaborating in the management of the video content kept in the originating member-created folder to the same extent as the originating member, for the video content kept in the originating member-created folder at the time of the designation of the at least one other member and up until the at least one other member is deleted as a member for the folder.

It will also be understood that according to aspects of embodiments of the disclosed subject matter management and collaboration in building can be independent of the owner/source of the content utilized. As an example, if a number of friends and family are attending, e.g., a birthday party for grandpa, it makes no difference who snapped which photograph or video stream. All of the contributors can use their own photographic/=video devices, increasingly everyone individual phones with ever more sophisticated and high resolution photography capabilities. Supposing there are six content collectors in a back yard at the party, snapping photos and making motion videos of each other. Assuming they all get uploaded to the album created according to aspects of embodiments of the disclosed subject matter with, e.g., each of the six being at least member/collaborators and perhaps all being starred, the day after the party and the creation of the album, no one would remember who added which photo or like video content. Unlike other existing systems and methods, where this is a very large facto in the creation, maintaining and otherwise managing a collection of photographs and other content from a group of user/contributors, the members/collaborators according to the present system and method are all equal owners of the content stored on the system. In existing systems the uploader and only the uploader has rights over the uploaded video content, i.e., photos and motion videos. According to aspects of embodiments of the disclosed subject matter, the content, in the form, e.g., of the digital memories for an entire group of people can be stored together, and everyone has equal right over each photo and motion video, at least while still a member. If a starred user/member decides to remove another user from an album, the removed member gets a copy of the album as of that point, but otherwise, so far as the other members are concerned nothing has changed other than a possible source of addition related content and comments being gone. Anyone can delete other peoples photos from the album for a selected period of time, e.g., the first 7 days of the content existing in the album, e.g., for reasons of privacy or propriety or the like, but after that the content is preserved for the entor group as that group grows or otherwise changes over its life.

The following is a disclosure by way of example of a known computing device which may be used with the presently disclosed subject matter. The description of the various components of a computing device is not intended to represent any particular architecture or manner of interconnecting the components. Other systems that have fewer or more components may also be used with the disclosed subject matter. A communication device may constitute a form of a computing device and may at least include, contain, utilize or emulate a computing device. The computing device may include an interconnect (e.g., bus and system core logic), which can interconnect such components of a computing device to a data processing device, such as a processor(s) or a microprocessor(s) or a controller(s), or other form of partly or completely programmable or pre-programmed device, e.g., hard wired and/or application specific integrated circuit (“ASIC”) customized logic circuitry, such as may implement, e.g., a controller or microcontroller, a digital signal processor, or any other form of device that can fetch and perform instructions, operate on pre-loaded/pre-programmed instructions, and/or follow instructions found in hard-wired or customized circuitry, such as above noted forms of hard-wired circuitry containing logic circuitry, in order to carry out logic operations that, together, perform steps of and whole processes and functionalities as described in the present disclosure.

In this description, various functions, functionalities and/or operations may be described as being performed by or caused by software program code to simplify description. However, those skilled in the art will recognize that what is meant by such expressions is that the functions resulting from execution of the program code/instructions are performed by a computing device as described in the present application, e.g., including a processor, such as a microprocessor, microcontroller, logic circuit or the like noted above. Alternatively, or in combination, the functions and operations can be implemented using special purpose circuitry, with or without software instructions, such as using an Application-Specific Integrated Circuit(s) (ASIC) or a Field-Programmable Gate Array(s) (FPGA), which may be programmable, partly programmable or hard wired. The application specific integrated circuit (“ASIC”) logic may be such as gate arrays or standard cells, or the like, implementing customized logic by metalization(s) interconnects of the base gate array ASIC architecture or selecting and providing metalization(s) interconnects between standard cell functional blocks included in a manufacturer's library of functional blocks, etc. Embodiments can thus be implemented using hard wired circuitry without program software code/instructions, or in combination with circuitry using programmed software code/instructions.

Thus, the techniques are limited neither to any specific combination of hardware circuitry and software, nor to any particular tangible source for the instructions executed by the data processor(s) within the computing device, such as a tangible machine readable medium. In other words, as an example only, part or all of the machine readable medium may in part or in full form a part of the, or be included within the computing device itself, e.g., as the above noted hard wiring or pre-programmed instructions in any memory utilized by or in the computing device.

While some embodiments can be implemented in fully functioning computers and computer systems, various embodiments are capable of being distributed as a computing device including, e.g., a variety of architecture(s), form(s) or component(s). Embodiments may be capable of being applied regardless of the particular type of machine or tangible machine/computer readable media used to actually effect the performance of the functions and operations and/or the distribution of the performance of the functions, functionalities and/or operations.

The interconnect may connect the data processing device to defined logic circuitry including, e.g., a memory. The interconnect may be internal to the data processing device, such as coupling a microprocessor to on-board cache memory, or external (to the microprocessor) memory such as main memory, or a disk drive, or external to the computing device, such as a remote memory, a disc farm or other mass storage device(s), etc. Commercially available microprocessors, one or more of which could be a computing device or part of a computing device, include a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation, as examples.

The inter-connect in addition to interconnecting such as microprocessor(s) and memory may also interconnect such elements to a display controller and/or display device, and/or to other peripheral devices such as an input/output (I/O) device(s), e.g., through an input/output controller(s). Typical I/O devices can include a mouse, a keyboard(s), a modem(s), a network interface(s), a printer(s), a scanner(s), a digital or video camera(s) and other devices which are well known in the art. The interconnect may include one or more buses connected to one another through various forms of a bridge(s), a controller(s) and/or an adapter(s). In one embodiment an I/O controller may include a USB (Universal Serial Bus) adapter for controlling a USB peripheral(s), and/or an IEEE-1394 bus adapter for controlling an IEEE-1394 peripheral(s).

The storage device, i.e., memory may include any tangible machine readable media, which may include but are not limited to recordable and non-recordable type media such as a volatile or non-volatile memory device(s), such as volatile RAM (Random Access Memory), typically implemented as a dynamic RAM (DRAM) which requires power continually in order to refresh or maintain the data in the memory, and a non-volatile ROM (Read Only Memory), and other types of non-volatile memory, such as a hard drive, flash memory, detachable memory stick, etc. Non-volatile memory typically may include a magnetic hard drive, a magnetic/optical drive, or an optical drive (e.g., a DVD RAM, a CD ROM, a DVD or a CD), or other type of memory system which maintains data even after power is removed from the system.

A server could be made up of one or more computing devices. A server can be utilized, e.g., in a network to host a network database, compute necessary variables and information from information in the database(s), store and recover information from the database(s), track information and variables, provide interfaces for uploading and downloading information and variables, and/or sort or otherwise manipulate information and data from the database(s). In one embodiment a server can be used in conjunction with another computing device(s) positioned locally or remotely to execute instructions, e.g., to perform certain algorithms, calculations and other functions as may be included in the operation of the system(s) and method(s) of the disclosed subject matter, as disclosed in the present application.

At least some aspects of the disclosed subject matter can be embodied, at least in part, in programmed software code/instructions. That is, the functions, functionalities and/or operations and techniques may be carried out in a computing device or other data processing system in response to its processor, such as a microprocessor, executing sequences of instructions contained in a memory or memories, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as a “computer program(s),” or “software.” The computer program(s) typically comprise instructions stored at various times in various tangible memory and storage devices, e.g., in a computing device, such as in cache memory, main memory, internal disk drives, and/or above noted forms of external memory, such as remote storage devices, such as a disc farm, remote memory or databases, e.g., accessed over a network, such as the Internet. When read and executed by a computing device, e.g., by a processor(s) in the computing device, the computer program causes the computing device to perform a method(s), e.g., process and operation steps to execute an element(s) as part of some aspect(s) of the system(s) or method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations as noted above. Further, the program software code/instructions can be obtained from remote storage, including, e.g., through centralized servers or peer to peer networks and the like. Different portions of the software program code/instructions and data can be obtained at different times and in different communication sessions or in a same communication session, e.g., with one or many storage locations.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways may be used for obtaining the software program code/instructions and data may occur, as an example, for different applications, components, programs, objects, modules, routines or other sequences of instructions or organization of sequences of instructions. Thus, it is not required that the data and instructions be on a single machine readable medium in entirety at any particular instant of time or at any instant of time ever.

In general, a tangible machine readable medium can include any tangible mechanism that provides (i.e., stores) information in a form accessible by a machine (e.g., a computing device), which may be included, e.g., in a communication device, a network device, a personal digital assistant, a mobile communication device, whether or not able to download and run applications from the communication network, such as the Internet, e.g., an I-phone, Blackberry, Droid, or the like, a manufacturing tool, or any other device including a computing device, comprising, e.g., one or more data processors, etc. In an embodiment(s), a user terminal can be a computing device, such as in the form of or included within a PDA, a cellular phone, a notebook computer, a personal desktop computer, etc. Alternatively, any traditional communication client(s) may be used in some embodiments of the disclosed subject matter. While some embodiments of the disclosed subject matter have been described in the context of fully functioning computing devices and computing systems, those skilled in the art will appreciate that various embodiments of the disclosed subject matter are capable of being distributed, e.g., as a system, method and/or software program product in a variety of forms and are capable of being applied regardless of the particular type of computing device machine or machine readable media used to actually effect the distribution.

The disclosed subject matter may be described with reference to block diagrams and operational illustrations or methods and devices to provide the system(s) and/or method(s) according to the disclosed subject matter. It will be understood that each block of a block diagram or other operational illustration (herein collectively, “block diagram”), and combination of blocks in a block diagram, can be implemented by means of analog or digital hardware and computer program instructions. These computing device software program code/instructions can be provided to the computing device such that the instructions, when executed by the computing device, e.g., on a processor within the computing device or other data processing apparatus, the program software code/instructions cause the computing device to perform functions, functionalities and operations of the system(s) and/or method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of the system(s) and/or method(s) presented and described as a flowchart(s) in the form of a block diagram in the present application are provided by way of example only, and in order to provide a more complete understanding of the disclosed subject matter. The disclosed flow and concomitantly the method(s) performed as recited in the accompanying claims are not limited to the functions, functionalities and operations illustrated in the block diagram(s) and/or logical flow(s) presented in in the disclosed subject matter. Alternative embodiments are contemplated in which the order of the various functions, functionalities and operations may be altered and in which sub-operations described as being part of a larger operation may be performed independently or performed differently than illustrated or not performed at all.

Although some of the drawings may illustrate a number of operations in a particular order, functions, functionalities and/or operations which are not now known to be order dependent, or become understood to not be order dependent, may be reordered. Other functions, functionalities and/or operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. Such embodiments are provided by way of example only. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. Numerous variations, changes, and substitutions will now occur to those skilled in the art without departing from the disclosed subject matter. It should be understood that various alternatives to the embodiments of the disclosed subject matter described as part of the disclosed subject matter may be employed in practicing the disclosed subject matter. It is intended that the following claims define the scope of the disclosed subject matter and that methods and structures within the scope of these claims and their equivalents be covered by the following claims.

What is claimed is:

1. A method for managing content of a network-based shared folder comprising:
creating, via a user computing device having Internet access, an originating member-created folder;
selecting, via the user computing device, originating member selected content and incorporating the originating member selected content into the originating member-created folder;
designating, via the user computing device, at least one other user as a member collaborating in the management of the content kept in the originating member-created folder to the same extent as the originating member, for the content kept in the originating member-created folder at the time of the designation of the at least one other member and up until the at least one other member is removed as a member for the folder.

2. The method of claim 1 further comprising:
allowing, via the user computing device, after the at least one other member is removed from being an at least one other member, the at least one other member access to a replica of the content of the originating member-created folder, which exists in the originating member-created folder at the time the at least one other member is deleted from being an at least one other member.

3. The method of claim 1 wherein the folder comprises an album.

4. The method of claim 1 wherein the content comprises at least one of a still digital image and a moving digital image.

5. The method of claim 2 further comprising:
selecting content from the replica of the content of the originating member-created folder to place into a removed member-created folder; and
removing data from the content prior to moving the content to the removed member-created folder.

6. The method of claim 5 further comprising:
inviting members to the removed member-created folder.

7. The method of claim 1 further comprising one or more of:
acting as a member of the originating member-created folder, selecting an additional member to add to the or delete from the video content in the originating member-created folder; and
acting as a member of the originating member-created folder, being selected by the originating member as a starred member for the originating member-created folder and having the ability to select an additional starred member for the originating member-created folder.

8. The method of claim 1 wherein each folder remains private to the existing members of the folder.

9. The method of claim 1 further providing:
preventing any member of an originating member-created folder having more than one member, from deleting content from the originating member-created folder after the passage of a selected period of time.

10. An apparatus for managing the content of a network-based shared folder comprising:
a user computing device configured to:
create a network-based originating member-created folder;
select originating member selected content and incorporate the originating member selected content into the originating member-created folder;
designate at least one other user as a member collaborating in the management of the content kept in the originating member-created folder to the same extent as the originating member, for the content kept in the originating member-created folder at the time of the designation of the at least one other member and up until the at least one other member is removed as a member for the originating member-created folder.

11. The apparatus of claim 10 further comprising:
the user computing device configured to:
allow, after the at least one other member is removed from being an at least one other member, the at least one other member access to a replica of the content of the originating member-created folder, which exists in the originating member-created folder at the time the at least one other member is deleted from being an at least one other member.

12. The apparatus of claim 10 wherein the folder comprises an album.

13. The apparatus of claim 10 wherein the content comprises at least one of a still digital image and a moving digital images.

14. The apparatus of claim 11 further comprising:
selecting content from the replica of the content of the originating member-created folder to place into a removed member-created folder; and
removing data from the content prior to moving the content to the removed member-created folder.

15. The apparatus of claim 12 further comprising:
inviting members to the removed member-created folder.

16. The apparatus of claim 10 further comprising one or more of:
acting as a member of the originating member-created folder, selecting an additional member to add to the or delete from the video content in the originating member-created folder; and
acting as a member of the originating member-created folder, being selected by the originating member as a starred member for the originating member-created folder and having the ability to select an additional starred member for the originating member-created folder.

17. The apparatus of claim 11 wherein each folder remains private to the existing members of the folder.

18. The apparatus of claim 11 further providing:
the user computing device configured to:
prevent any member of an originating member-created folder having more than one member from deleting video content from the originating member-created folder after the passage of a selected relatively short period of time.

19. The apparatus of claim 11 further comprising:
the user computing device configured to:
provide to the user an Internet-based software-as-a service (“SAS”) application, as one of an application accessible through the user computing device and running on the user computing device, including storage space available through the SAS; and
allow the respective members of a folder to share the cost of one of the SAS service and the storage.

20. A machine readable medium storing instructions that, when executed by a computing device, cause the computing device to perform a method for managing curation of the content of a network-based shared folder, the method comprising:
creating a network-based originating member-created folder;
selecting, via the user computing device, originating member selected content and incorporating the originating member selected content into the originating member-created folder;
designating, via the user computing device, at least one other user as a member collaborating in the management of the content kept in the originating member-created folder to the same extent as the originating member, for the content kept in the originating member-created folder at the time of the designation of the at least one other member and up until the at least one other member is removed as a member for the folder.
